(19) United States
(12) Patent Application Publication
(10) Pub. No.: US 2002/0023207 A1
(43) Pub. Date: Feb. 21, 2002

(54) Secure data transfer between a client and a back-end resource via an intermediary

(76) Inventor: Zbigniew T. Olik, Rochelle Park, NJ (US)

Correspondence Address: JOEL MILLER, ATTORNEY AT LAW, 17 WESTWOOD DRIVE SOUTH, WEST ORANGE, NJ, 07052, US

(21) Appl. No.: 09/880,461

(22) Filed: Jun. 13, 2001

Related U.S. Application Data
(60) Provisional application No. 60/115,835, filed on Jan. 14, 1999.
(60) Provisional application No. 60/211,256, filed on Jun. 13, 2000.

(51) Int. Cl. H04L 9/00

(52) U.S. Cl. 713/153; 705/75

(57) ABSTRACT

Data can be securely passed between a client and a back-end resource by utilizing an intermediary or proxy that substitutes references for data and functions as if it were in fact a client. When sending service requests to a web-server on a publicly-accessible site, the intermediary replaces the data with references; when it receives references from the publicly-accessible site, it replaces those references with the actual data. At no time is actual data handled by a publicly-accessible site.

### CROSS-REFERENCE TO RELATED APPLICATION

This application claims the benefit of U.S. Provisional Application No. 60/115,835 filed Jan. 14, 1999, U.S. application Ser. No. 09/481,140, filed Jan. 12, 2000, and U.S. Provisional Application No. 60/211,256 filed Jun. 13, 2000, incorporated by reference herein.

### BACKGROUND OF THE INVENTION

In an on-line system, when data is retrieved from a remote resource, each intermediate point through which it travels may conceivably access the data. Even if such data is retrieved through a secure connection with a web server, the web server itself will be privy to the data. While the web server is beneficial in that it acts as intermediary between a client and a remote resource, it would be advantageous to utilize the services of the web server without having to compromise the data.

### BRIEF DESCRIPTION OF THE DRAWINGS

FIG. 1 is a block diagram of a system affording secure data transfer;

FIG. 2 is a flow chart of a download procedure for the system of FIG. 1;

FIG. 3 illustrates the flow of commands and data between the components of FIG. 1 for the download procedure of FIG. 2;

FIG. 4 is a flow chart of an upload procedure for the system of FIG. 1; and

FIG. 5 illustrates the flow of commands and data between the components of FIG. 1 for the download procedure FIG. 4.

### DESCRIPTION OF THE INVENTION

Secure transfer of data between a client and back-end resources over the Internet can be achieved in part by establishing a secure path between the two points. Formatting and protocol issues not requiring access to secure data can be delegated to conventional elements in the path.

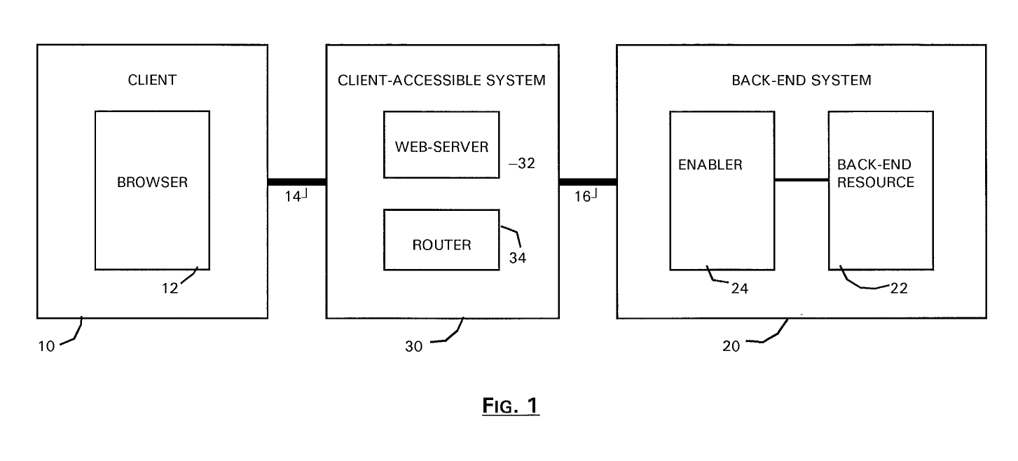

In one configuration, illustrated in the block diagram of FIG. 1, a client 10, using an Internet browser 12 equipped with the means necessary to create a secure session, accesses a back-end system 20 on which a back-end resource 22 resides, through a client-accessible system 30. The back-end resource 22 may be a database or some other source of data or device that the client wishes to access.

The interconnection 14 between the client 10 and the client-accessible system 30 can be over a network such as the Internet or through some other medium. Similarly, the interconnection 16 between the client-accessible system 30 and the back-end system 20 can be over a network such as the Internet or through some other data link.

An enabler 24 on the back-end system 20 functions as an interface between the back-end resource 22 and external connections to the back-end system 20, such as the interconnection 16. Information coming from or going to the interconnection 16 passes through the enabler 24 or, alternatively, passes to the back-end resource 22 under the direction and control of the enabler 24.

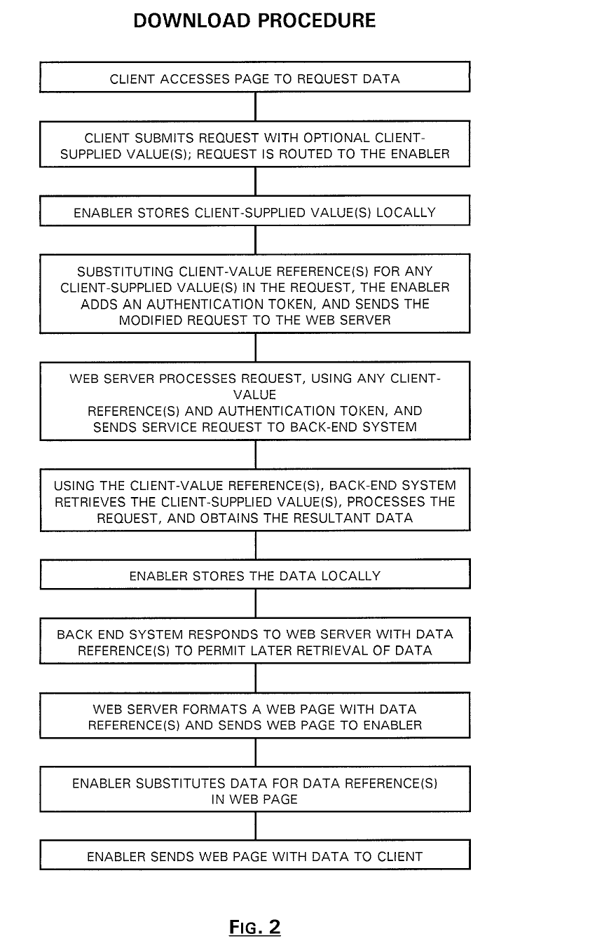

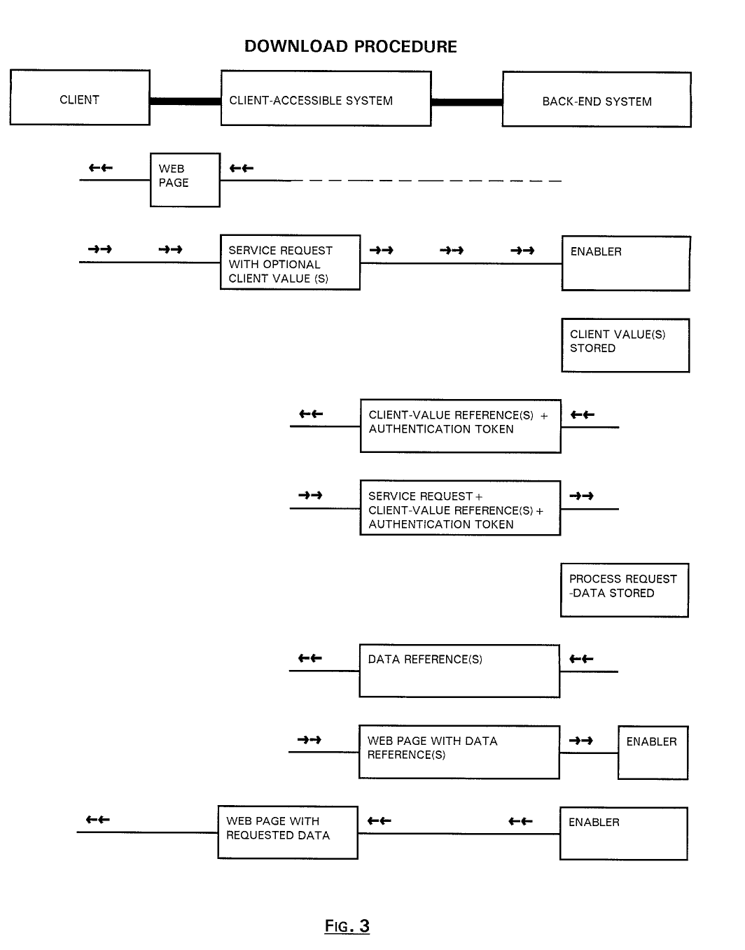

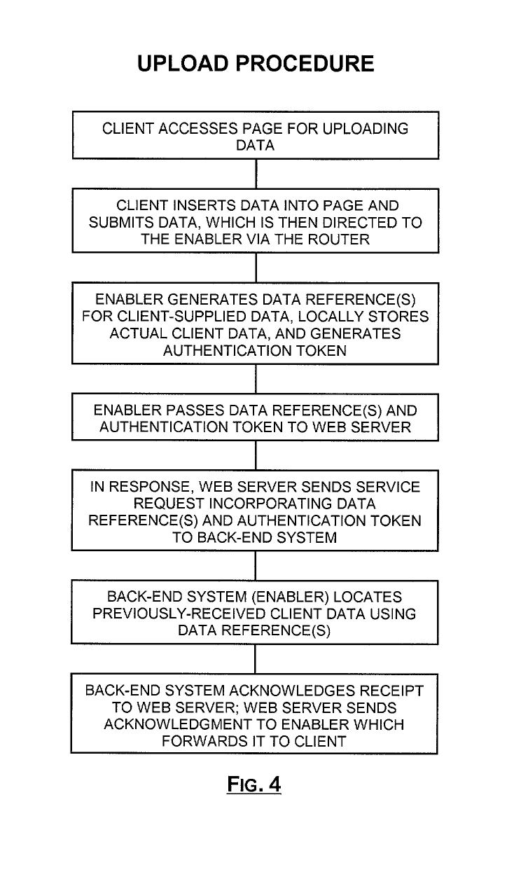

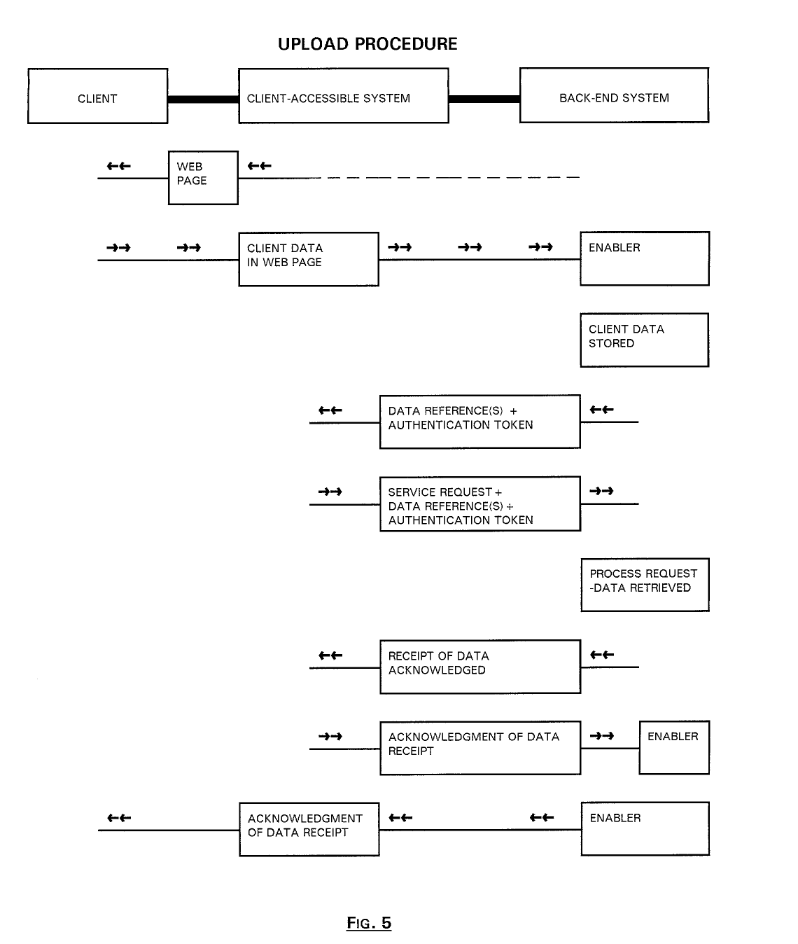

The data transfer process can be described in two parts: a download procedure (FIGS. 2 and 3), where data is transferred from the back-end resource to the client, and an upload procedure (FIGS. 4 and 5), where data travels from the client to the back-end resource. Either can be used alone, in concert with each other, or with other processes as appropriate.

Download Procedure

As shown in FIGS. 2 and 3, the client 10 initially accesses a web page for a download request. The page may be resident on the web server 32, the back-end system 20, or some other location. The client 10 may optionally insert a client-supplied value (or values) in the web page to complete the request and the request is then directed to the enabler 24 by way of a router 34. A digital certificate or some other means may be used to determine and convey identity of the client 10 to the enabler 24.

If the response contains any client-supplied value(s), the enabler 24 stores them locally, i.e., on the back-end system 20, and then creates one or more client-value references that function as a surrogate for those values. The enabler then modifies the request, incorporating any client-value references (instead of the client-value) and an authentication token, and sends the modified request to the web server 32.

The web server 32 in turn processes the request for a download, treating any client-value references it receives from the enabler 24 as data. It then sends a service request to the back-end system 20. The service request may be received by the enabler 24 and, incorporating any client-value reference(s), the enabler 24 retrieves the corresponding client-supplied value(s), processes the request, and obtains the data sought by the client 10 from the back-end resource 22. Alternatively, the back-end resource 22 may receive the service request directly. In that event, the back-end resource 22 will obtain the corresponding client-supplied value(s) from the enabler 24, process the request, and obtain the data sought by the client 10.

If the enabler 24 receives the service request, the enabler 24 then stores the data locally (on the back-end system 20), responding to the web server 32 on behalf of the back-end system 20 with data reference(s) to permit later retrieval of the actual data. If however the back-end resource 22 receives the service request, the back-end resource 22 will then query the enabler 24 which in turn will store the data locally, and provide data reference(s) that the back-end resource 22 will send to the web server 32.

The web server 32 now formats a web page using the data reference(s) (instead of actual data) and sends this web page externally to the enabler 24. The enabler 24 uses the data reference(s) to retrieve the data from the back-end system 20, replaces the data reference(s) in the web page with the actual data, and sends the web page to the client 10.

In following the procedure outlined above, the web server 32 never sees any client data, neither values supplied by the client or data from the back-end resource 22. To further insure security, the path between the client 10, i.e., its browser 12, and the enabler 24 via the router 34 can be made secure by utilizing a secure protocol such as SSL (“secure socket layer”). Similarly, the path between the web server 32 and the back-end system 20 (whether it be to the enabler 24 or the back-end resource 22) can utilize a secure protocol. The enabler 24 thus serves as an intermediary or proxy, appearing to the web server 32 as if it were in fact a “client,” as well as shielding data passing to and from the back-end resource 22 from the web-server 32.

Upload Procedure

The procedure for an upload of data from the client 10 to the back-end system 20, shown in FIGS. 4 and 5, is a subset of the download procedure just described. The client 10 initially accesses a web page on the web server 32 (or elsewhere) to request an upload. The client 10 inserts the data to be uploaded into the web page. The client 10 sends the data as part of an http (“hypertext protocol”) request, which is directed to the enabler 24.

In response to the request, the enabler 24 stores the client-supplied data locally, i.e., on the back-end system 20, and then creates one or more data references that function as a surrogate for the data. The enabler 24 then modifies the request, incorporating the data references (instead of the client's data) and an authentication token, and sends the modified request to the web server 32.

The web server 32 in turn processes the request for a upload, treating the data references it receives from the enabler 24 as data. It then sends a service request to the back-end system 20. There, it is intercepted by the enabler 24 and, using the data reference(s), the back-end system 20 retrieves the data and completes the service request, forwarding the data to the back-end resource 22. Alternatively, the back-end resource 22 receives the service request and is assisted by the enabler 24 in obtaining the data to be uploaded.

Finally, the back-end system 20 acknowledges receipt of the data, sending the acknowledgment to the web server 32, which in turn forwards it to the enabler 24 and then on to the client 10.

As with the download procedure, the paths between the client 10 and the enabler 24, and the web server 32 and the back-end system 20 can be secure.

The method described here can also be utilized to assist in logging traffic to and from the back-end system 20. Since the enabler 24 either receives every transaction or is monitoring the transactions, it can keep an audit log of all traffic in and out of the back-end system 20, noting the content, origin, destination, time, and date.

If desired, authentication can be performed using any method including the method described in provisional patent application No. 60/106,290, filed Oct. 30, 1998, and U.S. application Ser. No. 09/429,373, filed Oct. 28, 1999, both titled “Secure Authentication for Access to Back-End Resources,” and incorporated by reference herein.

What is claimed is:

1. A method for utilizing an intermediary resident on a back-end system to transfer data from a back-end resource on the back-end system to a client via network-based client-accessible systems containing web servers, comprising the steps of:
receiving a request from the client at the intermediary;
presenting the request to a web-server, which the web-server forwards to the back-end system in the form of a service request;
receiving a formatted web-page from the web-server with data references provided by the intermediary via the back-end system; and
replacing the data references with the requested data and sending the page to the client.

2. A method as set forth in claim 1, where the step of receiving a service request from a client includes the step of receiving at least one client value, storing the client value on the back-end system for later retrieval, and replacing the data in the service request with reference values that identify the stored values.

3. A method as set forth in claim 1, further including the step of initially establishing a secure connection between the client and the intermediary.

4. A method as set forth in claim 1, where the step of receiving a request from the client comprises the step of authenticating the client.

5. A method as set forth in claim 1, further comprising the step of logging data transactions at the intermediary.

6. A method for utilizing an intermediary resident on a back-end system to send a request to transfer data from a back-end resource on the back-end system to a client via network-based client-accessible systems containing web servers, comprising the steps of:
receiving a request from the client at the intermediary; and
presenting the request to a web-server, which the web-server forwards to the back-end system in the form of a service request.

7. A method as set forth in claim 6, further comprising the step of logging data transactions at the intermediary.

8. A method for utilizing an intermediary resident on a back-end system to transfer data from a back-end resource on the back-end system to a client via network-based client-accessible systems containing web servers, comprising the steps of:
receiving a formatted web-page from the web-server with data references provided by the intermediary via the back-end system; and
replacing the data references with the requested data and sending the page to the client.

9. A method as set forth in claim 8, further comprising the step of logging data transactions at the intermediary.

10. A method for utilizing an intermediary resident on a back-end system to transfer data from a client to a back-end resource on the back-end system via network-based client-accessible systems containing web servers, comprising the steps of:
receiving a request and data from the client at the intermediary;
storing the data on the back-end system and inserting at least one data reference in the request;
presenting the request to a web-server, which the web-server forwards to the back-end system in the form of a service request; and
replacing the data references with the client data and sending the service request to the back-end resource.

11. A method as set forth in claim 10, further including the step of initially establishing a secure connection between the client and the intermediary.

12. A method as set forth in claim 10, where the step of receiving a request from the client comprises the step of authenticating the client.

13. A method as set forth in claim 10, further comprising the step of logging data transactions at the intermediary.

14. A method for utilizing an intermediary resident on a back-end system to send a request to transfer data from a back-end resource on the back-end system to a client via network-based client-accessible systems containing web servers, comprising the steps of:
receiving a request and at least one client value from the client at the intermediary;
storing the client value on the back-end system for later retrieval;
replacing the client value in the request with at least one reference value that identifies the stored values; and
presenting the request to a web-server, which the web-server forwards to the back-end system in the form of a service request.

15. A method as set forth in claim 14, further comprising the step of logging data transactions at the intermediary.
